(19) United States
(12) Patent Application Publication
(10) Pub. No.: US 2017/0325451 A1
(43) Pub. Date: Nov. 16, 2017

(54) Use of Alkyl Gallate for Stimulating the Natural Defenses of Plants

(71) Applicant: Université Clermont Auvergne, Clermont-Ferrand (FR)

(72) Inventors: Pascale Goupil, Perignat-les-Sarlieve (FR); Razik Benouaret, Beaumont (FR); Claire Richard, Beaumont (FR)

(73) Assignee: Université Clermont Auvergne, Clermont-Ferrand (FR)

(21) Appl. No.: 15/526,155

(22) PCT Filed: Nov. 16, 2015
(86) PCT No.: PCT/FR2015/053080

§ 371 Date: May 11, 2017

(30) Foreign Application Priority Data
Nov. 14, 2014 (FR) 14 61034

(51) Int. Cl. A01N 37/40

(52) U.S. Cl. CPC A01N 37/40

(57) ABSTRACT

The invention relates to the use of alkyl gallate for stimulating the natural defenses of plants and to a method for stimulating the natural defenses of plants, which includes the application of a composition including an alkyl gallate on said plants.

### FIELD OF THE INVENTION

The present invention relates to the use of an alkyl gallate for the elicitation of a plant.

### CONTEXT OF THE INVENTION

Good health and good growth of a plant are needed for its development and for obtaining an advantageous yield for the farmer. However, plants are perpetually exposed to attacks by pathogens. Reinforcing the defenses of the plant against these pathogens is thus a crucial factor in the effectiveness of plant resistance.

Conventionally, potentially toxic plant protection products (fungicide, insecticides) are used in massive amounts to fight the attack of pathogens, and this use has a major impact on the environment with potential toxicity for humans.

The elicitation of plants with respect to pathogens is the focus of numerous research efforts. Development of synthetic organic products started in the 1980s. Probenazole, a precursor of saccharin, was the first such product used and remains in use against rice pyriculariosis in Japan. In the same period, phosethyl-Al was developed; this molecule and its principal metabolite, phosphonic acid, are particularly effective against oomycetes. Various products containing phosethyl-aluminum are currently approved and marketed in France, the phosethyl-Al concentration of which varies from 30 to 80% with or without other active material. The phytosanitary companies then marketed molecules which mimic the action of salicylic acid which by itself can induce immunity. As example, we cite the chemical analog of salicylic acid, 2,6-dichloroisonicotinic acid or other synthetic elicitors such as benzothiadiazole. Other compounds also present an elicitation activity, such as beta-aminobutyric acid (BABA) which is a synthetic compound.

The effectiveness of these compounds is often partial, specific to certain plant species or varieties, or specific to the developmental stage of the plants. Certain compounds have great potential (BABA), but are expensive to produce in large quantities. They must most frequently be used in combination with chemical treatments. In addition, their action can be limited in time, and these compounds can exhibit phytoxicity when used at high doses.

Therefore, a need exists for a compound that is friendly to the environment and to the plants for which it is intended, and that stimulates their defense system against pathogens.

Surprisingly, the present inventors found that an alkyl gallate had such an effect. The alkyl gallate proposed thus has the capacity of eliciting a treated plant.

Thus, the object of the invention, according to a first aspect, is the use of an alkyl gallate for the elicitation of a plant.

According to a second aspect, another object of the invention is a method for the elicitation of a plant, which includes the application of a composition including an alkyl gallate on said plant, the alkyl gallate being the only active agent of said composition.

### DETAILED DESCRIPTION OF THE INVENTION

### Use

According to a first aspect, the invention relates to the use of an alkyl gallate for the elicitation of a plant.

In the sense of the present invention, the term “alkyl gallate” denotes a gallic acid ester represented by Formula 1:

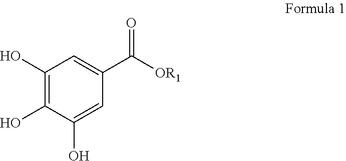

wherein R₁ is an alkyl group.

In the sense of the present invention, the term “alkyl group” denotes a linear or branched hydrocarbyl group of formula C_{z}H_{2z+1}, where z is a whole number from 1 to 12. Alkyl group examples are methyl, ethyl, propyl, isopropyl, butyl, isobutyl, sec-butyl, tert-butyl, and isopentyl.

According to a preferred embodiment, one uses an alkyl gallate in which the alkyl group is a linear alkyl group including from 1 to 10 carbon atoms, preferably from 1 to 6 carbon atoms.

According to a particularly preferred embodiment, one uses an alkyl gallate in which the alkyl group is selected from the group including methyl, ethyl and propyl.

These compounds exist advantageously in the natural state in certain berries and other plants, such as grapes. Therefore, they can be used in organic farming. In addition, these compounds are water soluble and are used as food additives. Consequently, they are easy to use, since their dilution is easy (for example, in a composition), and they do not require the wearing of particular protective equipment, such as a breathing mask.

In the sense of the present invention, the term “elicitation of a plant” denotes the stimulation of the natural defenses of a plant. Elicitation does not involve any direct interaction of the alkyl gallate with a pathogen of the plant.

The elicitation of a plant manifests itself in at least one mechanism selected from synthesis by said plant of autofluorescent compounds, alkalinization of the extracellular medium of said plant, accumulation by said plant of transcripts that are markers of the defense reactions.

The use of an alkyl gallate for the elicitation of a plant can manifest itself in the synthesis of autofluorescent compounds of the phytoalexin type around the infiltration sites without inducing chlorosis. This translates the eliciting effect of alkyl gallate and also highlights its lack of phytotoxicity.

The autofluorescent compounds of the phytoalexin type are synthesized within a time period of 1 to 10 days after the use of the alkyl gallate, in particular within a time period of 2 to 7 days, particularly within a time period of 4 days.

The use of an alkyl gallate for the elicitation of a plant can also manifest itself by rapid alkalinization of the extracellular medium of said plant. This phenomenon corresponds to modifications of the ion flow within the plasma membrane with massive inflows of protons. This activation of ionic channels constitutes an early event in the interaction of the plant cells with an elicitor.

The alkalinization of the extracellular medium is characterized by a variation in pH of less than 0.05 pH/min, in particular of 0.0001 pH/min to 0.03 pH/min, and more particularly of 0.001 pH/min to 0.025 pH/min within 60 minutes after the application of the alkyl gallate. The total variation of the extracellular pH is from 0.1 to 2, in particular from 0.2 to 3, and more particularly from 0.8 to 2.

The use of an alkyl gallate for the elicitation of a plant can manifest itself by the accumulation of the transcripts that are markers of the defense reactions PR1 (antimicrobial), PR2 (glucanase), PR3 (chitinase) and PR5 (antifungal thaumatin) by said plant.

The accumulation of the transcripts can be measured by quantitative real-time PCR. The higher the total relative quantity of transcripts accumulated is, the more abundant the transcripts are, the stronger the elicitor effect is and the more it will allow the synthesis of a large quantity of antimicrobial agents. In particular, 4 days after the use of an alkyl gallate, the total relative quantity of said accumulated transcripts is at least 2, in particular at least 20, and more particularly at least 50.

In the sense of the present invention, the term “total relative quantity of said accumulated transcripts” is understood to mean the total quantity of said accumulated transcripts in a treated plant when compared to an untreated plant.

The use according to the invention is entirely appropriate for a plant selected from the group including agronomically useful plants and the ornamental plants.

The agronomically useful plants are selected from the group of the angiosperms including the Apiaceae, Asteraceae, Brassicaceae, Chenopodiaceae, Convolvulaceae, Cucurbitaceae, Fabaceae, Liliaceae, Polygonaceae, Rosaceae, Solanaceae, Poaceae, and Vitaceae.

A single application of an alkyl gallate on a plant before the attack of a pathogen may be sufficient to achieve elicitation of said plant. However, the modalities of application do naturally depend on the species of plants to be treated and on the developmental stage thereof; consequently it may sometimes prove necessary to apply the alkyl gallate at least one more time several days or several weeks after the first application.

### Method

According to a second aspect, the invention also relates to a method for elicitation of a plant, which includes the application of a composition including an alkyl gallate on said plant, the alkyl gallate being the only active agent of said composition.

The composition used in the method according to the invention can be in the form of a powder or in liquid form.

According to one embodiment, when the composition is in liquid form, it furthermore includes a stabilizer, an additive and/or a preservative.

According to a particular embodiment of the method according to the invention, the composition is an aqueous composition which is applied by infiltration or by spraying of the leaves or roots.

According to a particularly preferred embodiment, the composition is an aqueous composition which is applied by spraying of the leaves.

The alkyl gallate concentration in the composition used in the method according to the invention is from 0.1 mmol·L¹ to 10 mmol·L⁻¹, preferably from 0.5 mmol·L⁻¹ to 7.5 mmol·L⁻¹, even more preferably from 2 mmol·L⁻¹ to 5 mmol·L⁻¹.

The method according to the invention can be used on agronomically useful plants and ornamental plants. Such plants are those mentioned above in connection with the use.

The invention will be described in further detail below in reference to the following examples which are given only for illustration.

### EXAMPLES

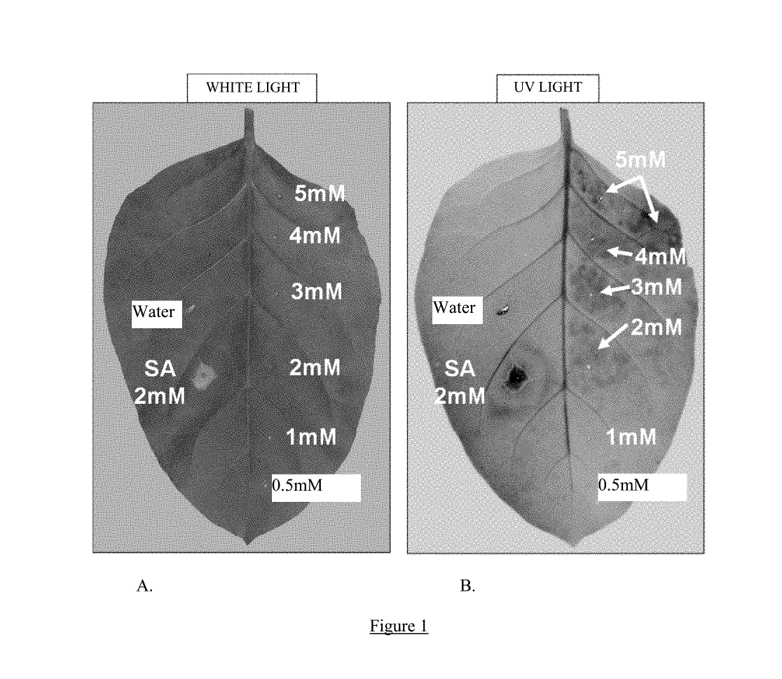

The examples are illustrated by FIGS. 1 to 7.

In FIGS. 1 to 7, the molar concentration of the solutions tested, in mmol·L⁻¹, is symbolized by “mM.”

FIG. 1 represents two photographs of a tobacco leaf under natural light (A) and ultraviolet light (312 nm wavelength) (B), 4 days after the infiltration of ethyl gallate solutions (EG solution) at different molar concentrations (from 0.5 mmol·L⁻¹ to 5 mmol·L⁻¹) (on the right) and of salicylic acid (SA) solutions having a molar concentration of 2 mmol·L⁻¹ and of water as positive and negative controls, respectively.

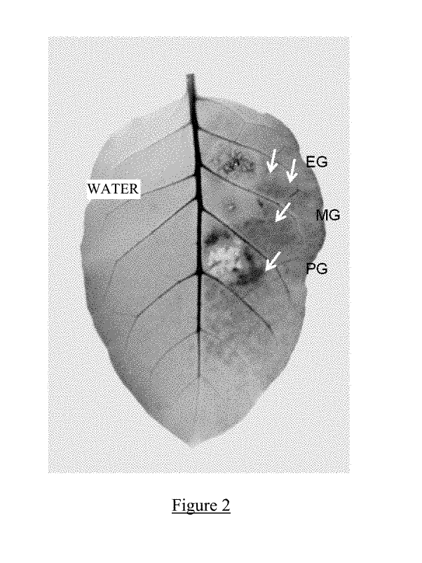

FIG. 2 represents a photograph of a tobacco leaf under ultraviolet light (312 nm wavelength), 4 days after infiltration of solutions of ethyl gallate (EG solution), methyl gallate (MG solution) and propyl gallate (PG solution) having a molar concentration of 5 mmol·L⁻¹, and of water as a negative control.

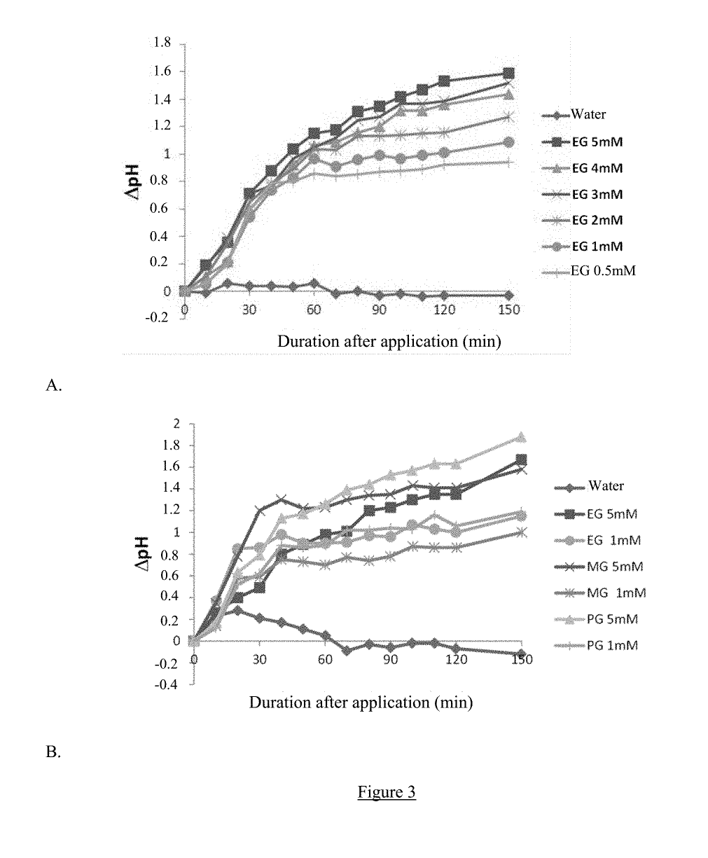

FIG. 3 represents two graphs monitoring the extracellular pH of the BY-2 culture media after the addition of EG solutions at different molar concentrations (from 0.5 mmol·L⁻¹ to 5 mmol·L⁻¹) (A) and EG, MG and PG solutions at molar concentrations (1 mmol·L⁻¹ and 5 mmol·L⁻¹) (B). In both cases, water is used as a control.

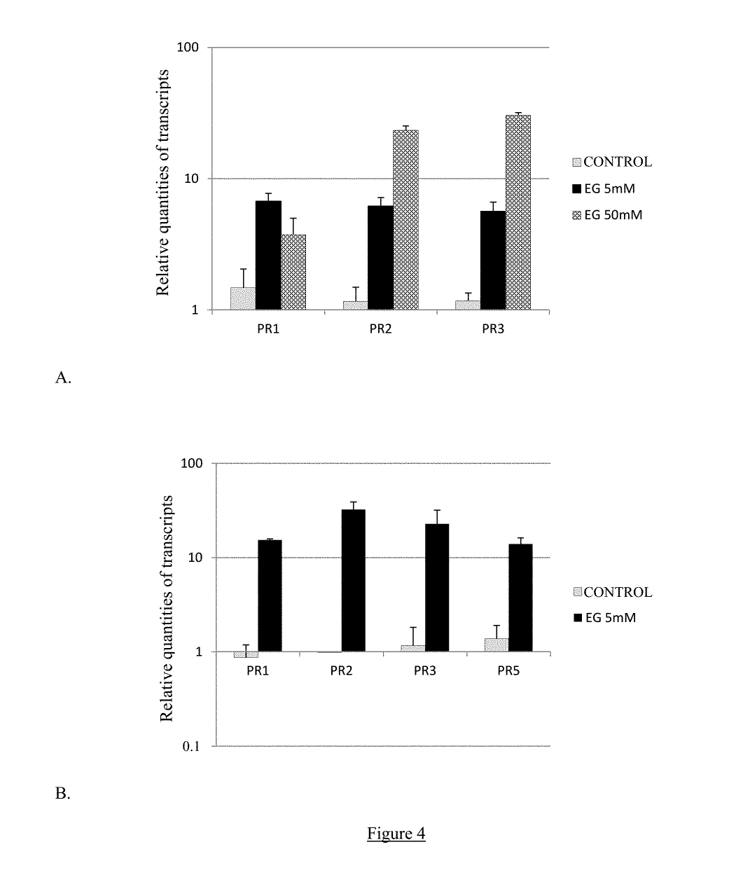

FIG. 4 represents two graphs indicating the relative quantities of transcripts coding for pathogenesis-related proteins (proteins PR1, PR2, PR3 and PR5) measured by quantitative PCR on tobacco leaves infiltrated (A) or sprayed (B) with EG solutions having molar concentrations (from 5 mmol·L⁻¹ and 50 mmol·L⁻¹) (B). In both cases, the control corresponds to water.

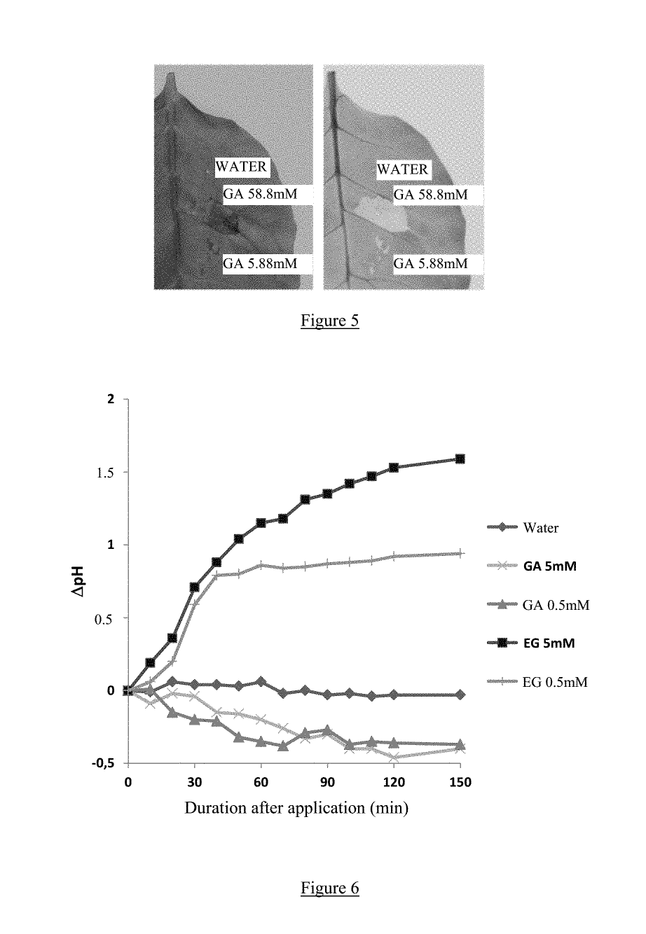

FIG. 5 represents two photographs of a tobacco leaf under natural light (A) and ultraviolet light (312 nm wavelength) (B), 4 days after the infiltration of solutions of gallic acid (GA solution) at different molar concentrations (6 mmol·L⁻¹ and 60 mmol·L⁻¹), and of water (negative control).

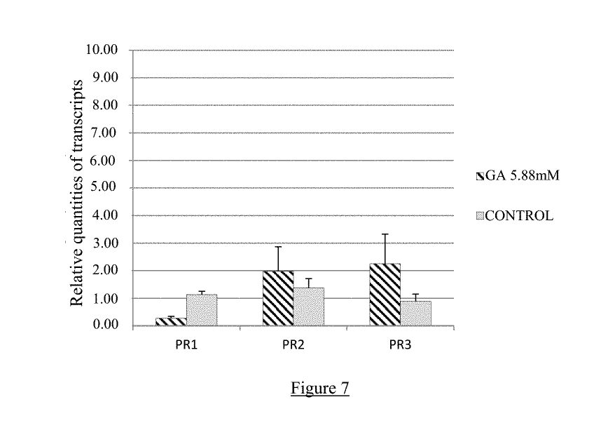

FIG. 6 represents a graph monitoring the extracellular pH of the BY-2 culture media after the addition of GA and EG solutions at different molar concentrations (0.5 mmol·L⁻¹ and 5 mmol·L⁻¹). Water is used as a control.

FIG. 7 represents a graph indicating the relative quantities of transcripts coding for pathogenesis-related proteins (proteins PR1, PR2 and PR3) measured by quantitative PCR on tobacco leaves infiltrated with a GA solution having a molar concentration of 6 mmol·L⁻¹. The control corresponds to water.

### MODEL PLANT AND ALKYL GALLATE SOLUTIONS TESTED

In the following Examples 1 to 3, different alkyl gallate solutions are tested on tobacco plants (model plant) to show the defense reactions of these plants. The plants are 8 weeks old, in the 12-15 leaf stage, cultured in a greenhouse or growing chamber.

The cell cultures are tobacco BY-2 cells maintained in cultures at 24° C., under stirring in darkness.

The different alkyl gallates (methyl, ethyl and propyl gallates) are supplied by Sigma-Aldrich. These chemical compounds are in the form of a powder and dissolved in water to obtain the MG, EG or PG solutions at different molar concentrations (from 0.5 mmol·L⁻¹ to 50 mmol·L⁻¹).

### Example 1: Absence of Chlorosis and Synthesis of Autofluorescent Compounds

Procedure

50 μL of different EG solutions having molar concentrations (0.5 mmol·L⁻¹ to 5 mmol·L⁻¹) and of MG and PG solutions having a molar concentration of 5 mmol·L⁻¹ are infiltrated on the upper side of the tobacco leaf. The negative control is water; the positive control is salicylic acid (SA) at a molar concentration of 2 mmol·L¹.

Result

The different plants are photographed 4 days after the infiltration. The results are presented in FIGS. 1 and 2.

In the photograph on the left of FIG. 1, one sees that the EG solutions do not induce chlorosis, while in the photograph on the right one can see extensive production of autofluorescent compounds of the phytoalexin type around the infiltration sites. The concentration of autofluorescent compounds increases with the molar concentration, but the autofluorescent compounds are observed only at concentrations from 2 mmol·L⁻¹ to 5 mmol·L¹.

In the photograph of FIG. 2, one can see that the MG and PG solutions induce the same phenomenon of production of autofluorescent compounds around the infiltration sites.

### Example 2: Alkalinization

Procedure

EG solutions (molar concentrations from 0.5 mmol·L⁻¹ to 5 mmol·L⁻¹), MG (1 mmol·L⁻¹ and 5 mmol·L⁻¹), or PG solutions (1 mmol·L⁻¹ and 5 mmol·L⁻¹) are added to tobacco BY-2 cell cultures at time T₀. The pH is measured continuously (every 10 min) in the extracellular medium for 150 minutes.

Result

The results are presented in FIG. 3.

In graphs A and B of FIG. 3, one can see that the MG, EG and PG solutions induce a rapid alkalinization of the extracellular medium for molar concentrations ranging from 2 mmol·L⁻¹ to 5 mmol·L⁻¹.

Indeed, regardless of the MG, EG and PG solution, the extracellular pH increases by a value ranging from 0.6 to 1.4 during the first 60 minutes. Between 60 and 150 minutes, the increase in the pH is less rapid and corresponds to a value ranging from 0.1 to 0.6. In total, after 150 minutes, the value of the extracellular pH increased by a value ranging from 0.8 to 2.

The higher the molar concentration of the MG, EG and PG solutions, the greater is the increase in the pH.

### Example 3: Accumulation of the Transcripts

Procedure

The markers for the acquired local response (ALR) are tested for in the tobacco leaves that have been treated by the infiltration method (20 infiltration points per leaf/50 μL per infiltration) or by spraying (sufficient quantity to cover the leaf and obtain saturation, or approximately 2 mL per leaf) at a rate of 3 leaves per plant (non-senescent basal leaves). The leaves treated are separated from the plant 4 days after treatment and frozen immediately in liquid nitrogen for grinding and extraction of the total RNA. The RNA is extracted in the presence of CTAB buffer according to the protocol described by Chang et al. (1993) [Chang S, Puryear J, Cairney J (1993) A simple and efficient method for isolation RNA from pine trees. Plant mol Biol rep 11: 113-116]. The total RNA is purified and treated by DNase I (1 U) and RNase inhibitor (40 U) (Euromedex), in order to eliminate any possible contamination of the genomic DNA. The total RNA assay is run on the spectrophotometer (NanoDrop-1000). The integrity of the RNA is checked by agarose gel electrophoresis (1%) by detection of the ribosomal RNA subunits. The complementary DNA is synthesized from 1 μg of total RNA using Euroscript Reverse Transcriptase (Eurogentec). The PCR reactions are carried out with the Mastermix for SYBR GREEN kit (Eurogentec) using the iCycler iQ5 software (Bio-Rad). The specificity of the amplification is verified by melting curve analysis. The gene coding for EF-1α is used as an internal control. The quantification of the transcripts is calculated according to the mathematical model developed by Pfaffl (2001). [Pfaffl (2001) A new mathematical model for relative quantification in real time RT-PCR. Nucl. Acids res 29: 2002-7].

Result

The results are presented in FIG. 4.

As illustrated in graphs A and B of FIG. 4, the EG solutions having molar concentrations of 5 mmol·L¹ and 50 mmol·L¹ induce the accumulation of transcripts that are markers of the defense reactions: PR1, PR2, PR3, PR5 in the tobacco leaves treated either by filtration or by spraying.

Table 1 lists the relative quantities of the transcripts measured. The values indicate that an application by spraying makes it possible to accumulate more transcripts. Application by spraying of an ethyl gallate solution would thus be more effective than application by infiltration in order to elicit a plant.

TABLE 1

| | Method of | Relative quantities of transcripts | | | |
|---|---|---|---|---|---|
| | application | PR1 | PR2 | PR3 | PR5 |
| EG | Infiltration | 3.7 ± 1.3 | 23.4 ± 3.3 | 30.4 ± 5.3 | Undetermined |
| 50 mmol · L⁻¹ | | | | | |
| EG | Infiltration | 6.7 ± 1.2 | 6.2 ± 1.7 | 5.6 ± 1.3 | Undetermined |
| 5 mmol · L⁻¹ | | | | | |
| EG | Spraying | 15 ± 0.4 | 32 ± 4.6 | 23 ± 7.1 | 14 ± 2.2 |
| 5 mmol · L⁻¹ | | | | | |

### Example 4: Comparison with Gallic Acid

In this example, different gallic acid (GA) solutions are tested on the same tobacco plants as previously.

The cell cultures are tobacco BY-2 cells maintained in cultures at 24° C., under stirring and in darkness.

The gallic acid is supplied by Sigma-Aldrich and dissolved in water in order to obtain solutions of different concentrations (GA solution).

Chlorosis and Synthesis of Autofluorescent Compounds

Procedure

Two GA solutions (58.8 mmol·L⁻¹ and 5.88 mmol·L⁻¹) are infiltrated on the upper surface of the tobacco leaf. The negative control is water.

Result

The different plants are photographed 4 days after the infiltration. The results are presented in FIG. 5.

By comparing the photographs of FIG. 5, one can see that the GA solutions induce strong chlorosis, which is not accompanied by autofluorescent zones around the infiltration zones, suggesting the phytotoxic and non-eliciting character of GA.

Alkalinization

Procedure

Two GA solutions (0.5 mmol·L⁻¹ and 5 mmol·L⁻¹) are added to tobacco BY-2 cell cultures at time T₀. The pH is measured continuously (every 10 min) in the extracellular medium for 150 minutes. EG solutions at different molar concentrations (0.5 mmol·L⁻¹ and 5 mmol·L⁻¹) are used as controls.

Result

The results are presented in FIG. 6.

The graph of FIG. 6 shows that, in contrast to the EG solutions, the GA solutions have no effect on the pH of the culture medium.

Accumulation of Transcripts

Procedure

The tobacco leaves infiltrated with a GA solution having a molar concentration of 5.88 mmol·L⁻¹ are checked for the presence of markers for the acquired local response (ALR).

4 days after the infiltration, the transcripts coding for pathogenesis-related proteins (PR proteins) are measured by quantitative real-time PCR. The total RNA is extracted from the infiltrated tobacco leaves. The cDNA is synthesized, and the transcripts of interest are quantified using specific primers of the genes PR1, PR2 and PR3.

Result

The results are presented in FIG. 7.

As illustrated in the graph of FIG. 7, the infiltrated GA solution does not induce a significant accumulation of transcripts when compared to water.

### Conclusion of the Examples:

Ethyl gallate induces various defense reactions within the tobacco leaf which has been treated (by infiltration), such as the production of autofluorescents of the phytoalexin type, without inducing chlorosis. This suggests that ethyl gallate is not phytotoxic. Ethyl gallate also induces the alkalinization of the extracellular medium of the tobacco BY-2 cultures, and the accumulation of PR transcripts.

All these mechanisms manifest the action of an elicitor on the plant cells. Methyl and propyl gallates also present an elicitation activity which has been demonstrated by the induction of autofluorescent compounds and the alkalinization of the extracellular medium of the BY-2 tobacco cultures.

In contrast, gallic acid does not stimulate the defense reactions.

1-3. (canceled)

4. A method for elicitation of a plant, comprising the application of a composition including an alkyl gallate on said plant, the alkyl gallate being the only active agent of said composition.

5. The method according to claim 4, wherein the composition is an aqueous composition which is applied by infiltration or spraying of the leaf or root.

6. The method according to claim 4, wherein the alkyl gallate concentration in the aqueous composition is from 0.1 mmol·L⁻¹ to 10 mmol·L⁻¹.

7. The method according to claim 4, wherein the plant is selected from the group consisting of agronomically useful plants, ornamental plants, aromatic plants and medicinal plants.

8. The method according to claim 5, wherein the composition is an aqueous composition applied by spraying of the leaf.
